(19) United States
(12) Patent Application Publication
(10) Pub. No.: US 2003/0089452 A1
(43) Pub. Date: May 15, 2003

(54) Apparatus and method for applying linerless labels

(75) Inventors: Thomas E. Hansen, St. Paul, MN (US); Robert Phillips, Eden Prairie, MN (US)

Correspondence Address: Mark A. Litman & Associates, P.A., York Business Center, Suite 205, 3209 West 76th St., Edina, MN, 55435, US

(73) Assignee: Advanced Label Systems, Inc.

(21) Appl. No.: 10/000,254

(22) Filed: Nov. 15, 2001

(51) Int. Cl. B32B 31/00

(52) U.S. Cl. 156/268; 156/510

(57) ABSTRACT

A method and apparatus useful in the application of linerless labels to surfaces of elements is provided in a methodology so that conventional linered label applicators can be used with linerless labels. A source of linerless labels is provided comprising a composite of an elongate sheet of reusable, temporary liner having adhered to a low adhesion surface of said reusable, temporary liner an adhesive face of a precut linerless label, the composite possibly being in a roll. The source of linerless labels is used in a method for enabling a linered label applicator to accept linerless label sheet for application to the surface of elements comprising associating a source of precut linerless labels on a roll of reusable, temporary liner sheet to a linered label applicator so that a composite of:

a) the reusable, temporary liner sheet and

b) preferably micro-bridged cut-out linerless labels

is fed into the linered label applicator where linered label is normally directed into the linered label applicator.

### BACKGROUND OF THE INVENTION

1. Field of the Invention

The present invention relates to the field of labels that are provided without separation liners between the labels and layers of supply of labels, and rolls, especially linerless labels provided in roll form. The present invention also relates to apparatus and methods for applying linerless labels to substrates. The present invention also relates to the use of thin liners on labels, especially linerless labels, and the use of microperfing of label stock prior to lamination with liners.

2. Background of the Invention

Labels which are not provided to commerce (either to intermediate users or end users) with liners over an adhesive face, referred to in the art as linerless labels, are less expensive than lined labels, more labels can be provided in a roll of a given diameter than conventional labels with release liners, and they are more environmentally friendly since they do not require the disposal of liners after use. (For example, any adhesively coated liner stock that is provided in roll form with no liner between an adhesive surface and the display surface of a label is an example of a linerless label. Linerless labels should also be less expensive since one entire element (the liner) may be removed from the manufacturing cost of the label. Liners can constitute 35% to 50% of the total cost of a lined label construction. For these and other reasons, linerless labels are achieving increased popularity. Equipment for applying linerless with rewettable or thermal sensitive adhesives to a wide variety of moving elements (such as substrates, bottles, or packages) is fairly common, as shown in U.S. Pat. Nos. 2,492,908 and 4,468,274. However, the application of unlined pressure sensitive adhesive labels to moving elements although known in the art, is uncommon (e.g., U.S. Pat. No. 4,978,415), and does not have the versatility to apply the labels to all sorts of moving elements, such as envelopes, webs, bottles, cans, and packages.

According to U.S. Pat. No. 5,674,345, a method and apparatus are provided which quickly, positively, and in a versatile manner apply linerless pressure sensitive adhesive labels to moving elements. The equipment and method are versatile since they may be utilized with envelopes, packages, substrates, bottles, cans, packages and a wide variety of other moving elements, and the method and apparatus typically are practiced so as to leave no skeletal web after the labels are formed, thus avoiding any necessity of disposing of any waste label material According to the apparatus of that invention, means for mounting a supply of linerless label tape having a release coated face and adhesive (typically pressure sensitive adhesive) face is associated with a number of novel apparatus elements according to the invention. These novel elements include a non-stick circumferential surface feed roll, a hardened vacuum anvil cylinder cooperating with a cutting cylinder having a radially extending knife blade, which in turn cooperates with a wiper roller that applies liquid release material to the blade after each cut, and transport means having many unique features. The transport means includes a plurality of conveyor tapes which are spaced in a direction transverse to the direction of conveyance of labels thereby, and a vacuum chamber assists the adhesive from the labels in maintaining the labels in position on the conveyor tapes during conveyance. The conveyor tapes are typically substantially circular in cross section so as to present a minimal area for engagement with the label adhesive, and the labels are separated from the conveyor tapes by a plurality of non-stick surface stripper rings which extend upwardly above the top surface of the conveyor tapes, and are associated with a peeler roller which bends the labels upwardly as they are deflected by the stripper rings. From the peeler roller and stripper rings the labels are moved directly into contact with a moving element. Where, as typical, the labels are moved into contact with moving envelopes, the labels and envelopes pass through nip rollers whereby the pressure sensitive adhesive is activated.

Linerless labels have also become increasingly more popular because of the many advantages associated therewith. When any labels, including linerless labels, are used, it also is necessary to be able to automatically print the labels in a cost-effective manner. One way this can readily be accomplished is by using a thermal printer, either a thermal printer having a thermal printhead with a thermal ribbon unwind and rewind system, or a thermal printer with a direct thermal printhead. Conventional thermal printers are not capable of printing linerless labels, however, because there will be surfaces thereof which necessarily come into contact with the uncovered adhesive face of the linerless labels as the labels are being fed to the printhead, during printing, or afterwards. According to U.S. Pat. No. 5,560,293, a variety of thermal printers are provided which overcome this problem and are eminently suited for effective printing of linerless labels. The linerless labels printed according to the present invention may be almost any type of linerless labels, such as for example, thermal ribbon embodiments shown in U.S. Pat. No. 5,354,588 and direct thermal printer embodiments such as shown in U.S. Pat. No. 5,292,713.

U.S. Pat. No. 5,560,293 describes a thermal printer which prints linerless labels in such a way that printer components will not stick to the adhesive face of linerless labels. Substantially stationary printer components, such as a label guide, transport plate, front panel, and stripper blade, preferably have the adhesive face engaging surfaces thereof plasma coated so that adhesive will not stick to them. An optional cutter provided downstream of the stripper blade also has plasma coated surfaces. A driven platen roller has a surface thereof coated with or covered by a high release silicone, which will not stick to the adhesive, but has high friction characteristics to facilitate drive of the labels. In a direct thermal printer, a plasma coated tear off surface is downstream of the driven platen roller, and stripper belts, a second roller with O-rings, and the like are provided to prevent the labels from wrapping around the driven platen roller. One or more sensors may also be provided for controlling drive of the platen roller in response to the position of registration marks on the linerless labels. According to one aspect of that invention a thermal printer for printing linerless labels, having an uncovered adhesive face, is provided comprising the following elements: a linerless label unwind; a substantially stationary label guide; a substantially stationary transport plate; a rotatable driven platen roller; a printhead cooperating with the print roller; and, the label guide and transport plate having surfaces which engage the adhesive face of linerless labels from the label unwind, the adhesive-engaging surfaces comprising plasma coated surfaces which substantially prevent the label adhesive from adhering thereto. The printhead preferably comprises a thermal printhead, and a thermal printer unwind and rewind system is associated with the printhead that provides the thermal ribbon between the printhead and the driven platen roller. The driven platen roller preferably has a peripheral surface thereof which is coated with a high release silicone which has both non-stick characteristics with respect to the adhesive face of the linerless labels, but also high friction characteristics to facilitate driving of the labels. Any other substantially stationary surfaces of the printer which are also likely to come into contact with the adhesive face of the linerless labels-such as a front panel-are also plasma coated. The transport plate may be grooved to minimize the surface area that engages the label adhesive face. The printer also preferably comprises a stripper blade/bridge mounted on the opposite side of the driven platen roller from the label unwind, in the direction of label conveyance through the printer. The stripper blade/bridge is positioned with respect to the driven platen roller and the printhead so as to prevent a printed label from being wound onto the driven platen roller and assists the label moving from the platen roller to the cutter. The stripper blade/bridge has a surface which has a non-stick feature, preferably a plasma coating, and typically the stripper blade/bridge may be mounted directly on a pre-existing tear bar on the printer. According to that invention a conventional thermal printer may readily be modified merely by substituting the particular non-stick label guide, transport plate, and driven platen roller according to the invention, and mounting the stripper blade/bridge on the existing tear bar.

Linerless labels are produced, for example, by feeding a tape having a release coated face and an adhesive face to a hardened anvil vacuum cylinder, utilizing a non-stick circumferential surface feed roll. A knife blade on a cutting cylinder is rotated into contact with the tape at the anvil cylinder to cut the tape into linerless labels, and release liquid is applied to the blade after each cut. From the anvil cylinder the labels are deposited on a plurality of spaced conveyor tapes of circular cross section with the adhesive faces contacting the conveyor tapes. A vacuum chamber assists in holding the labels on the conveyor tapes. The release coat faces of the labels conveyed by the conveyor tapes may be heated and then printed with hot melt ink from an ink jet printer. The labels are separated from the conveyor tapes using a peeler roll and non-stick stripper rings, and then immediately contact a moving web or other elements to which they are to be applied, with the label and web passing through nip rolls to activate the pressure sensitive adhesive.

In spite of the benefits that are obvious from the proposed and actual use of linerless labels, the growth of the technology has not been as rapid in commerce as has been expected. The reduced rate of acceptance is due at least in part because the present capability of application equipment is significantly slower than for lined labels. In production and supply, faster rates without waste are critical to levels of efficiency, productivity and profitability. Significantly slower equipment, such as the present linerless label application systems which operate at speeds one fourth to one half the speed of lined label applicators, reduce cost competitive aspects of the linerless label. Additionally, the cost of equipment specific to linerless labels requires an independent capital investment for equipment which is useful only for the linerless labels. For a manufacturer to convert from a lined label process or to add a lined label process to his business, a completely new apparatus has to be purchased. At a cost of hundreds of thousands of dollars, this is not a highly attractive scenario for labeling companies.

According to the invention described in U.S. Pat. No. 6,206,071, a method and apparatus are provided which quickly, positively, and in a versatile manner apply linerless pressure sensitive adhesive labels to moving elements. The equipment and method are versatile since they may be used with any substrate, including for example envelopes, packages, bottles, cans, packages and a wide variety of other moving elements, may be used with any available linerless label, and the method may be used on existing commercial apparatus by the addition of an inventive module according to practice of that present invention. The process of that present invention comprises associating the linerless label with a temporary, reusable support (temporary, reusable liner) on line or immediately before introduction to the label application apparatus, stripping the label from the temporary, reusable support, winding up the temporary support, and reusing the temporary support again to support a linerless label for introduction into commercial lined label applicators with stripping capability.

### SUMMARY OF THE INVENTION

The present invention provides an alternative method of using linerless label stock with conventional lined label application apparatus by applying linerless label stock to a reusable, temporary support before the linerless label stock is associated with apparatus directly connected to the lined label application apparatus. In this manner, the economic advantages of reusing the essentially continuous support layer used to carry the label stock into the applicator is continued, but also the roll of linerless stock material may be provided to the ultimate customer of the printshop or applicator shop without that ultimate customer having to be concerned even with the addition of supplemental apparatus such as the component described in U.S. Pat. No. 6,206,071. The apparatus on site with the ultimate customer does not have to be modified in any way from the conventional apparatus used to apply conventional liner label stock.

Linerless label stock is applied to a temporary reusable carrier with the label shapes precut or then cut while the stock is on the temporary support. The framing segments of the cut-out labels are removed prior to, during or after application of the linerless label stock to the reusable, temporary carrier. Printing of the labels may be done during manufacture of the linerless label stock, after manufacture of the linerless label stock, before cutting of the linerless label stock, after cutting of the linerless label stock, before application of the linerless label stock to the reusable, temporary support or after application of the linerless label stock to the temporary, reusable support.

An additional process and apparatus for the practice of the present invention comprises a means for reducing the amount of work that has to be performed on a single line, separating the work onto different lines and even different locations which can reduce crosscontamination problems of materials used in different segments of the overall process. Particularly the invention allows for printing onto sheets which are cut into materials which form rolls of labels or printing onto the material and directly rolling the printed sheets. Then on a separate line (distinct from the printing line), hot melt adhesive is applied to the face of the sheet away from the printing (or on the printed face if the label is to be applied printed surface down), preferably, but not necessarily before cutting into the roll width of the printed sheet. It is another surprising aspect of the invention that when the thin liner is present on the linerless label tock, the combined linerless label and thin liner stock may be slit without removal or damage to the thin liner. Because of the generally low adhesion between those layers, the slitting or converting operation might be expected to separate or wrinkle the layers. The printed sheet with adhesive is then cut (e.g., die cut) into the shape desired for the label, and the cut labels are applied (with the severed and separated matrix which surrounded the label) onto a reusable carrier or reusable liner to form a fully assembled label supply web with a reusable carrier. The matrix is subsequently removed from the fully assembled label supply web prior to rewinding into a completed roll. It is novel according to the present invention to form the roll in the order of printing onto the sheet, applying the adhesive, cutting the labels, and then applying the labels onto the reusable temporary carrier.

### BRIEF DESCRIPTION OF THE DRAWINGS

FIG. 1 shows a schematic of a module of the invention of U.S. Pat. No. 6,026,071 which can be added to a commercial lined label applicator.

FIGS. 2, 2A, and 2B show one format of apparatus according to the present invention where adhesive is applied to the label material after printing but prior to cutting and assembling on a temporary carrier.

FIGS. 3A shows a perspective view of a die with a micro-perforating design for cutting borders around labels.

FIG. 3B shows a cutaway view of an edge of a die with a micro-perforating opening in the die edge.

### DETAILED DESCRIPTION OF THE INVENTION

Linerless label tape conventionally has a label substrate, a release coated face and an adhesive (typically pressure sensitive adhesive, although thermal adhesives and solvent activatable adhesives are known) coated face. The linerless label is usually provided in roll form or stacked form, with the adhesive face of a sheet or roll in contact with the release coated face of another sheet or the adjacent rolled layer. The label is cut, partially cut or precut directly from the roll or sheet in the stack and applied to a substrate or element on which a label is to be applied. It is common in the art for the linerless label to be cut by a die, especially a cylindrical die, before the label is sent to the article to which the label is to be applied. The primary objective of the linerless label with respect to the more conventional lined label, is to eliminate the necessary step of disposing of the liner after the label is applied. This disposal is inconvenient, adds to the cost of the user, and usually increases the cost of the label material, since there is another layer of material which is present in any form of a linered label.

As previously noted, however, the use of linerless labels has been restrained by the need for additional capital expenditure as well as inefficiencies in the performance of the apparatus designed for linerless label application. The present invention addresses and reduces both of these concerns as an alternative to the apparatus, articles and methods of copending U.S. Pat. Nos. 6,206,071 and 6,294,038.

The present invention may be practiced in two ways. First, an apparatus may be constructed with the built in capability of temporarily securing a linerless label to a temporary, reusable support. Second, a module may be provided which can be attached to existing lined label applicator machines which enables those lined label applicators to apply linerless labels. Lined labels are applied to substrates or elements by feeding the lined label stock with liner into an applicator. The applicator may receive die-cut lined label stock or provide die cutting within the applicator itself. The label, after die cutting is stripped from the liner by a stripping element (e.g., blade, reduced pressure, scraper, flexer, peeler, bender or the like) and the shaped label (that is, a label shaped by the die cutting) is applied to the surface on which a label is desired. These systems for application of lined labels are readily available from various manufacturers and perform quite efficiently. The module of the present invention effectively creates a temporarily lined linerless label, removes the temporary liner, and then recycles the liner. By recycling the liner, which may be the same as or slightly modified from conventional liners, the disposal of liners is significantly reduced. By recycling a liner once, the costs of material and disposal for the liner are reduced 50%, and by recycling the liner the expected twenty or so times, the cost of the liner is reduced by 95%. Even by recycling a liner merely three times, which can be readily done with conventional label liner materials, the cost savings in materials and disposal for the liner is 75%. As can be seen from the cost efficiencies, only modest numbers of recycling need be done to provide significant economic advantage and significantly equivalent reductions in waste disposal costs. It is not essential to the practice of the present invention to recycle these liners, however.

It is important to note that there are unique capabilities provided to the field of the invention and the commercial potential in the practice of the invention through the use of thin backing sheets. The practice of the invention also uniquely enables the manufacture of unique structures, which are not known to be enabled by any other process.

To begin with, the term “thin backing sheet” or “thin liner” has a definite meaning within the practice of the present invention. In ordinary practices, backing sheets will normally be at least two mils (0.002 inches or 0.05 mm). This is especially true where mechanical processing, such as rotary die cutting of label stock supported on the liner, is to be performed. This significant thickness is required because the cutting operation is neither precise nor tolerant of thin layers. Wobble of layers and equipment, the essential need to assure that the facing stock is uniformly and completely cut through, wear of materials, wrinkles and folds, and other physical variables cause the die cuts to vary significantly. The process is operated with tolerances assuring that the die cut always goes completely through the stock and backside adhesive, and this means that it will also almost always penetrate into the liner. To assure that the liner is not cut all the way through and therefore cause the sheet to fall apart as there would be no continuous structural layer, the liner must be thick enough (e.g., at least about 0.05 mm) to assure that the die edge cuts into the liner, but does not cut all the way through the liner. Therefore a thin liner or thin backing sheet means a liner that is less than or equal to 1.25 mils (less than 0.032 mm). Preferably the liner is less than 1 mil (less than 0.0254 mm), more preferably less than 0.8 mil (0.0203 mm), less than 0.6 mil (less than 0.017 mm), and even as low as 0.25 mil or lower (0.00626 mm or lower). A preferred range is less than 1.0 mil (less than 0.0254 mm), less than 0.9 mil (less than 0.023 mm) between 0.3 and 1.0 mil (0.0076 through 0.0254 mm), 0.4 and 0.8 mils (approximately between 0.01 and 0.021 mm). Such thin backing material is commercially available as polyester film (e.g., 0.5 mil, 0.0127 mm) sheeting from Mitsubishi Chemical Company, and is known to be used as throwaway liner on tar adhesive roofing shingles. A related liner material is provided by Avery, Inc. as a 1.02 mil (0.026 mm) polyester backing sheet with a 1.25 mil (0.032 mm) adhesive layer. Avery FASSON® thin pressure sensitive label has a 0.7 mil (0.018 mm) liner.

The composition of the backing sheet may be any polymeric or even thin paper layer, such as polyester (e.g., polethyleneterephthalate, polyethylenenaphthalate), polyamide, polyvinyl resin, polyvinyl acetal resin, cellulosic resins (such as cellulose acetate, cellulose triacetate, etc.), and artificial papers, especially translucent/transparent compressed paper layers of the appropriate dimensions. Natural resins such as amylose resins may also be used. The surface of the layers may be physically or chemically treated to control its adhesion to the adhesive surface on the liner. Release layers, controlled release layers, and the like such as silicone resins, acrylate resins, epoxy resins, and mixed resin functionalities can be used as extremely thin coatings on the liner to control these properties as can corona discharge, sputtering, oxidation, laser discharge, or chemical reaction of the surface.

There is a definite technical problem in attempting to use a thin liner layer on label stock or linerless label stock. That technical problem arises, at least in part, from attempting to cut or die cut the label on the backing. As noted above, the cutting lacks the precision needed to cut consistently through the label without cutting through the liner. The liner is so thin that there is a regular occurrence of liner cut-through when the liner is used at commercial label converting speeds. Even when the die cutting speed is slowed on line to 25 feet (7.63 m) per minute, which is an extremely slow manufacturing speed, there is still some cut-through likely on line. As normal manufacturing processes for labels are sought to be at least 100 feet (28.6 m) per minute, and preferably at least 150 ft./min (42.9 m/min.) having to slow the process down to one fourth of standard speeds is a significant cost disadvantage. The present process enables a process to be practiced that can manufacture labels with thin liner, and completely avoid any potential for cut-through of the liner. This is a significant technical advance.

Another technical problem that arises is because of the speed of manufacturing that must be used to make the product more economical. As the speed increases, the likelihood of cut-through damage increases dramatically. Speed adds reduced alignment stability, reduced layer stability, less accuracy in the die-cutting, and the likelihood of stoppage of the manufacturing line is increased to address deficiencies. The process of the present invention, by completely eliminating even the possibility of cut-through damage, enables the potential for increased speeds, even beyond those of standard label manufacture or application systems.

The basic practices of the invention that enable these manufacturing improvements have advantages even beyond application to thin liners. One of these practices includes the use of ‘small-perfing,’ ‘micro-perfing’ or ‘micro-perforation’ of the label stock before application of the label stock to the liner. The procedure is more accurately termed ‘microbridging.’ The use of micro-perforation or microbridging techniques (which will be described in greater detail herein) provides a label that has been sufficiently cut in the desired pattern for separation into individual labels without the need for additional treatment (e.g., burr removal, trim cutting, etc.) and yet maintain the aesthetics needed for a high quality label. At the same time, the maintenance of a precut label sheet that can still be handled with a mechanical or manual system without difficulty is a significant advantage. Once a label stock sheet has been precut to form the labels, the labels will fall off the matrix, or have to be separately treated (as by vacuum lift-off). This is a significant advantage in and of itself, and can be a significant factor in the enablement of the use of thin liners.

The term micro-perfing, microbridging or micro-perforation as used in the practice of the present invention has a definite meaning according to the present invention. When a label is ordinarily cut from label stock or sheeting, the entire periphery of the label design is cut out, the label removed (without further tearing around the border), and the label applied to a product surface. Microbridging or Micro-perforation includes a process where less than 10% (preferably less than 8%, more preferably less than 5%) of the periphery of the intended outline or border of the label is left uncut in sections or bridges between the edge of the label and the matrix, with no single bridge exceeding 3% (preferably less than 2.5%, more preferably less than 2%, and still more preferably less than 1.5% or less than 1%) of the total border or where there are only single edges cut (with natural sides forming an edge of the label), as measured along the one or two connecting side(s) between labels cut from the same stock. The absolute dimensions of the bridges may also be defined. For example, each bridge should have a maximum dimension perpendicular to the direction of the border edge that is less than 1 mm, less than 0.8 mm, less than 0.6 mm, less than 0.5 mm, less than 0.4 mm, less than 0.3 mm, or less than 0.1 or less than 0.08 mm, for example, down to 0.05 mm. These small bridges are able to support a label within a matrix from the label stock (the matrix being a residue of label material that is usually disposed of after the label is removed), so that the entire stock (of matrix attached through bridges to the label) can be manipulated or operated on and transported, without having to treat the labels individually. There are usually at least two bridges, usually more than at least three bridges, and more usually four or more bridges around the microbridged label. It is preferred that there be 10 or fewer bridges, 8 or fewer bridges, and 6 or fewer bridges in the practice of the invention, with the labels running on average from 25 cm² to 1000 cm².

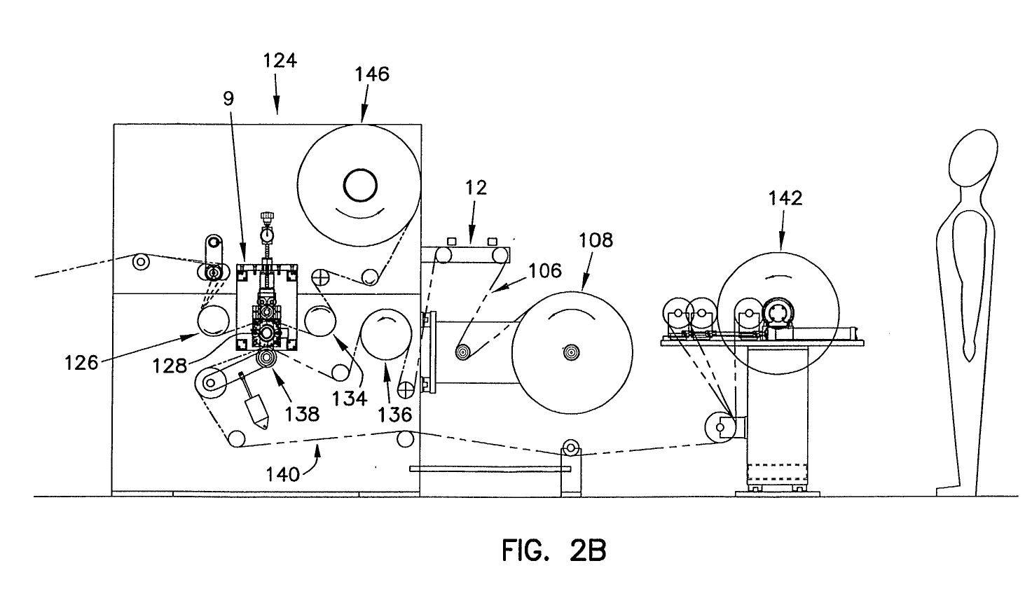

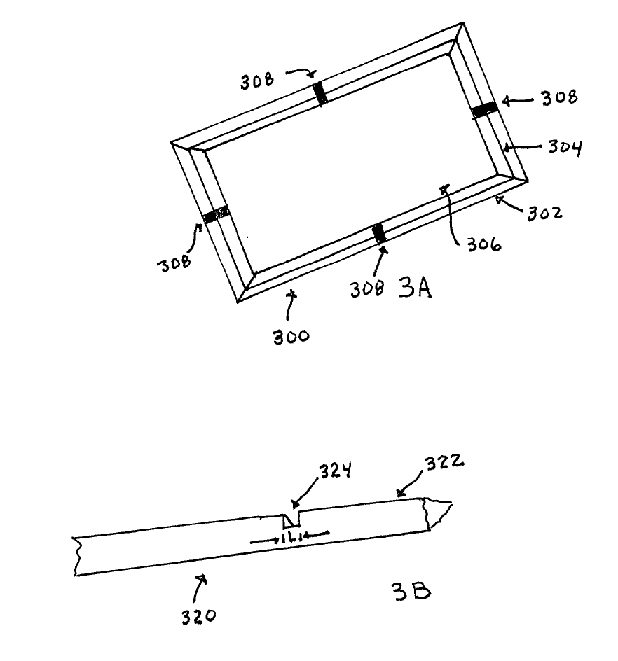

Micro-perfing, micro-bridging or small-perfing can be effected quite easily by the selection of appropriate dies in the die cutting procedure. Ordinarily, a die or die hammer or die set is designed or positioned to have the entire outline of the intended cut to be represented on one or more die parts as a complete and continuous edge. When the die is pressed against the surface to be cut, the edge will cut the label stock, and where there are openings in the die cutting-edge, a bridge will remain. This can be seen in reference to FIGS. 3A and 3B.

As shown in FIG. 3A, a rectangular die 300 is shown. The die 300 has a base 302, a raised sharp edge 304 and a floor 306. Gaps 308 are shown along the edge 304. These gaps 308 cannot cut into a label material and leave a bridge along the border cut into the label.

As shown in FIG. 3B, a raised die edge 320 is shown. The raised edge 320 has a cutting edge 322 with a gap 324 along the edge. The gap 324 cannot cut through a label when the die 320 is pressed against the label. The length L of the gap 324 will determine the dimension (width) of the microbridging along the line of the cut made to effect the separable border in the label. As noted elsewhere, the width or length of the gap 324 may range from less than 1 mm, to less than 0.8 mm, to less than 0.6 mm, to less than 0.5 mm, to less than 0.4 mm, to less than 0.1 mm and may be as small as enables the bridge formed in the cut to stabilize a label within the matrix, particularly in combination with a number of microperforation bridges or microbridges around the circumference or border of the pre-cut label within the matrix.

The term ‘microperfing’ is incidentally used or described in U.S. Pat. No. 4,945,709, although it is apparently used in the context of forming small holes in a material, as opposed to forming small bridges along a die cut or other cut along a border. U.S. Pat. No. 5,076,612 describes microperfing completely differently as printing paper marketed as “Microperf”. Such a known technique may be used to define edge portion 44 of a predetermined width, e.g., conveniently in the range ⅓-1 inch by providing fine closely-spaced perforations along line 48. In that case, the bridging material constitutes the majority of the border. U.S. Pat. Nos. 6,261,252 and 6,106,492 describe ‘microperf’ as a small cell foam.

Perforating is used quite extensively in label manufacturing, with even conventional postage stamps being considered a form of label. In these cases, a very large portion of the broader is retained (in the case of stamps, this percentage usually runs between 25 and 60 percent of the border being opened or perforated), with the bridge segments being approximately equal. The individual and equally sized bridges in these cases may constitute as much as 3-10% of the total border between adjacent stamps or sections.

Microbridging according to the present invention is performed by having a hole along the continuous line of the cutting edge of the die. The number and size of the holes determines the area that is not cut by the die and remains as a micro-bridge in the microbridged label edge.

That invention may at least in part be described as a module for adapting apparatus which strips liners from a label and applies labels to a substrate, the module enabling the apparatus to apply linerless labels, the module comprising:

a source of linerless label sheet,

a source of liner sheet,

a roll for guiding the linerless label sheet after removal from the source of linerless label,

a die cutter and an anvil roller defining an area through which linerless label sheet may move between said die cutter and anvil roller,

a laminator roller adjacent to the anvil roller defining an area between the anvil roller and the laminator roller through which both liner sheet and cut-out linerless labels from the linerless label sheet may move between the anvil roller and the laminator roller to form a temporary support of the liner for cut-out linerless label. The roll for guiding the linerless label web from the wound roll may, for example, comprise a top riding roller. Between the roll for guiding the linerless label and the anvil roller and die cutter, there may be a tension controller, such as a dancer, pneumatic or hydraulic tension controller, spring tension controller, and the like. The die cutter may be, for example, a reciprocating die cutter, hammer die cutter or a die cutting roller and anvil. In the operation of the module and apparatus, a matrix may be formed from removal of cut-out labels from the linerless label sheet and the matrix is wound on a take up roll. The module may be constructed as a single free-standing module within a frame or housing which may be attached to said apparatus. The free-standing frame or housing may have feed sources of the liner and/or the linerless label separated from the module or as separate independent modules or elements attached to or associated with the module where the linerless label sheet is cut and secured to a temporary, preferably reusable support or liner.

Where an anvil roller is used, the anvil roller may have openings on its surface through which reduced gas pressure (vacuum) may be applied to hold cut-out label as the anvil roller turns. To reduce any tendency of the die cutter to build up adhesive or other material on its surface, a lubricant may be applied to the die cutter, as by a lubricator applicator or supplier of lubricant or antistick liquid. An important contribution according to the invention is to use a chilled die cutting system, either or both of the cutting element and/or the supporting element, such as the rotary die, flat die, hammer, anvil, or the like.

In U.S. Pat. No. 6,294,038, an apparatus for applying labels to the surface of elements was created by positioning the module or multiple modules described above to feed a composite article comprising a temporary combination of said liner (e.g., temporary, reusable liner) and the cut-out linerless label and the apparatus including a separator or splitter (later described) for removing the cut-out linerless label from the temporary liner. The apparatus may also include a winding element for winding into a roll a matrix comprising liner from which cut-out linerless label has been removed. An apparatus is also provided for applying labels to the surface of elements, the apparatus comprising the module of the present invention positioned to feed a composite article comprising a temporary combination of said liner and said cut-out linerless label and said apparatus including:

a) a separator or splitter for removing cut-out linerless label from a temporary liner,

b) a winding element for winding into a roll a matrix comprising liner from which cut-out linerless label has been removed, and

c) a registration guide for linerless label between said roll for guiding said linerless label sheet after removal from the source of linerless label. The apparatus may provide the roll for guiding said linerless label as a top riding roller, and between the roll for guiding said linerless label and the anvil roller and die cutter, there may be a tension controller, and the die cutter may be a die cutting roller, and a matrix is formed from removal of cut-out labels from the linerless label sheet and the matrix is wound on a take up roll, and the anvil roller has openings on its surface through which reduced gas pressure may be applied to hold cutout label as the anvil roller turns. The reduced pressure or vacuum may be controlled on the surface of the anvil so there is a holding effect as the cut-out linerless label is transported to the laminator roller and then the reduced pressure is lowered, stopped or positive pressure introduced through the openings to assist removal of the combined temporary, reusable liner and the cut-out linerless label. This apparatus may have the module as a single free-standing module within a frame or housing which is attached to the apparatus. The apparatus may provide the anvil roller with openings on its surface through which reduced gas pressure may be applied to hold cut-out label as the anvil roller turns. The present invention can eliminate some of the structure in this process, for example, the vacuum support for the label, as the microperfing now enables the precut, micro-perforated label stock to be transported with the label attached by bridges to the matrix.

A method is also described in U.S. Pat. No. 6,206,071, for enabling a lined label applicator to accept linerless label sheet for application to the surface of elements comprising securing a module of the invention to a lined label applicator so that a composite of:

a) liner sheet as a temporary liner sheet and

b) cut-out linerless labels from the linerless label sheet

is fed into a lined label applicator where lined label is normally directed in the lined label applicator. A method of applying linerless labels to a substrate after enabling a enabling a lined label applicator to accept linerless label sheet for application to the surface of elements is also described wherein cut-out linerless label is removed from a temporary liner sheet, and the cut-out linerless label is applied to a substrate. This method may be further practiced whereby after removal of cut-out linerless label from the temporary liner sheet, the used temporary liner sheet is wound into a roll. Afterwards, the roll into which said temporary liner sheet is wound is used to feed liner as a source of liner sheet in a module comprising:

a source of linerless label sheet,

a roll for guiding linerless label sheet after removal from the source of linerless label,

a die cutter and an anvil roller defining an area through which linerless label sheet may move between a die cutter and anvil roller,

a laminator roller adjacent the anvil roller defining an area between the anvil roller and laminator roller through which both liner sheet and cut-out linerless labels from the linerless label sheet my move between the anvil roller and the laminator roller to form a temporary support of the liner for cut-out linerless label.

It is also desirable, as an alternative in the present invention, to provide a prerolled (and preferably preprinted) source of microperforated, partially separated or partially segmented linerless labels on a temporary support, which may or may not be a recyclable temporary support or a thin support. The source roll itself is also novel, as an adhesive-backed label, with a release coating on the surface to which the adhesive on the backing will not adhere, with micro-perforation bridges supporting the label to a matrix has not previously been provided on a liner, including a thin liner and a temporary, reusable liner.

The novel supply roll may be produced in a number of different ways, depending upon the manner in which the supply may be ultimately used. Among the more useful methods of constructing this format of pre-rolled linerless labels are:

1) providing a stream of linerless labels (e.g., with the adhesive coated thereon) off the manufacturing line, before being rolled, partially severing individual labels on the continuous sheet with the micro-perorating process of the invention, and applying the continuous sheet with the partially severed labels to the temporary support, and then rolling the label/support composite, with or without a core support;

2) providing a stream of linerless labels (e.g., with the adhesive coated thereon) off the manufacturing line, and before the label stock is rolled, partially severing individual labels on the continuous sheet through the micro-bridging techniques of the invention, and separating the labels from the cutoff framing segment(s) with the individual linerless labels spaced and supported on the reusable support, then rolling the micro-perforated label/support composite, with or without a core; the labels may be separated from the frame segment(s) before, during or after application of the labels so the temporary support (in any of these listed alternatives); and

3) providing a roll of linerless labels, unrolling the linerless labels, or partially forming or severing the individual labels by micro-perforation or micro-bridging techniques and associating the stream of labels (with or without the framing segment(s) with a temporary support, removing the framing segment(s) from the linerless label continuous sheet before, during or after association with the temporary support, except that the labels are partially severed on the temporary support, and then applying the individual label/support composite to a label applicator or rolling the label/support composite into a roll (with or without a core) before introduction to an applicator. By partially severed it is meant that the labels are shaped, but that some bridge remains between the label shape and the matrix.

In the practice of these three methods, a number of alternatives and options may be used. The labels or linerless label stock may be printed at any time, such as before application of the adhesive, before or after severing of the individual labels, before or after separation of the labels from the framing segment(s), or before or after application of the linerless labels to the temporary support.

The linerless label sheet or individual labels may be applied to the temporary support, may be partially severed or partially cut into micro-perforated individual labels, may be printed, and may be in any other way processed on commercially available equipment, and in similar processes as lined labels are treated. Once the roll or stream of linerless labels on temporary, reusable support material composite has been formed, it may be used in a manner similar to the linerless labels/temporary support composite manufactured in line as described above. The composite may then be fed into a conventional label applicator.

A method for enabling a linered label applicator to accept linerless label sheet for application to the surface of elements according to this invention may be described as comprising associating a source of microbridged, partially precut linerless labels on a roll of reusable liner sheet to the linered label applicator so that a composite of:

a) the reusable, temporary liner sheet and

b) micro-bridged cut-out linerless labels

is fed into the linered label applicator where linered label is normally directed into the linered label applicator. The micro-bridged cut-out linerless label may be removed from the temporary liner sheet, leaving the matrix behind by severing the micro-bridges by tearing, and the cut-out linerless label is applied to a substrate. After removal of cut-out linerless label from the temporary liner sheet, the temporary liner sheet would normally be wound into a roll, and may or may not be reused. After the temporary liner sheet is wound into a roll, the roll is unwound and linerless label may be applied again to the liner sheet to use it as a reusable, temporary liner sheet. After the roll is unwound and linerless label is applied to the temporary liner sheet to form a recycled roll, supported linerless label from the recycled roll is fed into the linered label applicator where linered label is normally directed into the linered label applicator. The roll is used to feed label on a reusable, temporary liner as a source of label, with the applicator normally operating by steps in the applicator comprising:

bending the linerless label on a reusable, temporary liner to partially remove at least a part of an edge of the linerless label from the reusable, temporary liner,

having at least the lifted edge placed into contact with a surface to which the linerless label is to be applied, and

attaching the linerless label to the surface.

As with the linerless label/temporary, reusable support composites manufactured in line, the temporary support is stripped from the labels in the applicator leaving the matrix behind by tearing the bridges formed by the micro-perforation process, the support rolled, and the support unrolled and new linerless labels or linerless label stock applied thereto.

Another way of provided rolled sheet material according to the present invention comprises a method for creating a label on a temporary reusable carrier comprising the steps of:

a) printing an image onto at least one face of a first sheet material;

b) applying adhesive to at least one face of the printed first sheet material;

c) pre-cutting the sheet material into individual labels by microbridging to leave bridges between the labels and a matrix;

d) applying a face of the individual labels to a temporary carrier sheet to form a sheet of label stock; and

e) rolling the sheet of label stock into a roll of label stock or using it within an applicator for linered labels.

The method will usually have label stock from the roll of label stock fed into a label applicator, where labels from the label stock are applied to substrates, and the temporary carrier is collected as a roll, with the matrix attached or with the matrix separately stripped from the carrier. The method also desirably has the collected roll of temporary carrier subsequently provided as a liner for labels. The method also is practiced by having the collected roll of temporary carrier (with the matrix removed) subsequently provided as a temporary reusable carrier after repetition of steps a), b) and c) on a second printed sheet material that is different from the first sheet material. By different from the first sheet is meant that it is a different sheet, not that the printing is required to be different on the second printed sheet material.

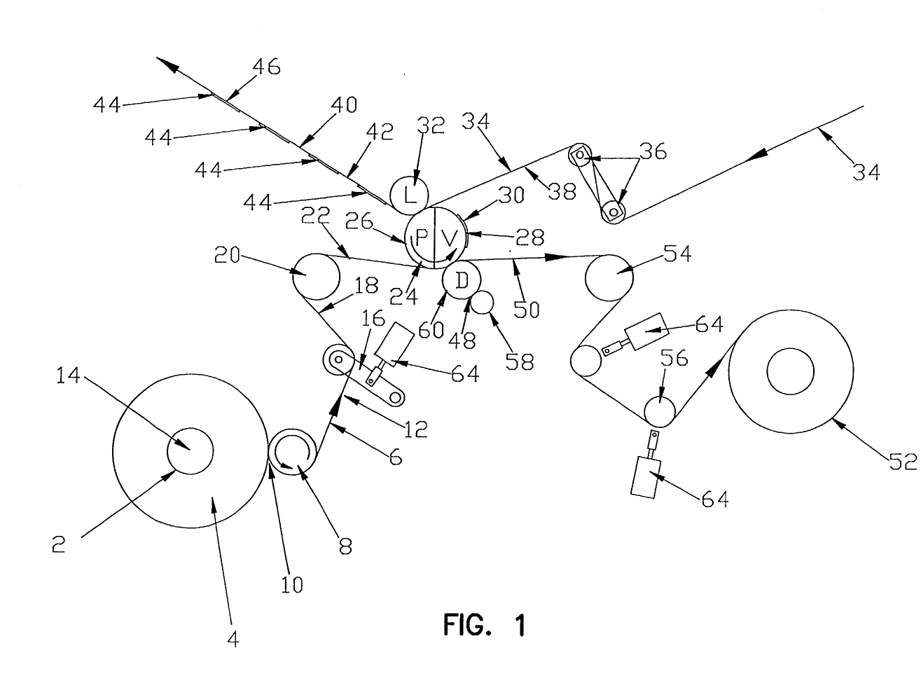

Reference to FIG. 1 will assist in explaining the module that can be used in the practice of U.S. Pat. No. 6,206,071. An unwind carrier 2 having a roll of linerless label 4 is provided. The unwind carrier 2 is preferably powered as this assists in controlling the tension on the linerless label 6. A roller 8, preferably a top riding roller 8, assists in the removal of the linerless label 6 at an angle at point 10, between the top riding roller 8 and the roll of linerless label 4. The roll of linerless label 4 preferably has the linerless label 6 rolled so that the adhesive face 12 of the linerless label faces the center 14 of the unwind 2. The linerless label 6 is optionally advanced in the system to a tension control element 16 which is optionally a dancer. It is also desirable to have the linerless label material 18 after removal advanced over a registration roll or pull/registration roll 20. These two elements, the dancer 16 and the registration roll or pull registration roll 20 are preferred embodiments, a site where the linerless label sheet 22 can be temporarily supported on a reusable carrier. In this figure, the linerless label sheet 22 is fed between an anvil roll 24 and a die cutter 48, so that a linerless label sheet 22 is fed towards cutter 48 facing the anvil roller 24. The cutter 48 will have a die face (not shown here, but described in FIGS. 3A and 3B) that enables microperforation of the label stock. The anvil roll 24, does not require a vacuum pressure anvil roller 24, but may have merely a support surface thereon. The anvil roller 24 has a surface 26 which faces die cutter 48 that severs the linerless label according to the micro-perforating design on the die face (not shown). The die cutter 48 faces the adhesive face of the linerless label 22 (with a thermal, pressure-sensitive, water- or organic solvent-soluble adhesive) to form the micro-perforating or micro-bridged cut along the border of a label in the sheet of linerless label 22. The non-adhesive face of the linerless label 22 may be partially severed (micro-perforated) by the die cutter 48, for example, by having an additional roller between the die cutter 48 and the laminator roll. The die cut linerless label 28 with its adhesive (e.g., pressure sensitive adhesive, thermal adhesive, solvent activated adhesive, etc.) face 30 is carried on the surface 26 of the anvil roll 24, with a die cutter 48 towards a laminator roll 32. A liner 34 is fed from a source (e.g., a roll, not shown) of recyclable/reusable liner material. Web steering guide rollers 36 may be used to direct the liner 34 towards the laminator roll 32. The liner 34, with its release coated surface 38 facing the adhesive coated surface 30 of the die cut linerless label 28 is laminated to the die cut linerless label 28 to form a temporary linerless label/carrier system 40 comprising a potentially reusable liner/carrier 42 having a series of previously linerless micro-perforated die cut labels 44 with their adhesive faces 46 against the potentially reusable carrier/liner. This temporary linerless label/carrier system 40 may be then treated and applied to a substrate by conventional lined label applicator systems (not shown) effectively as a lined label, even though provided initially as a linerless label. The matrix is removed from the lined linerless label material by application of a force sufficient to lift the label and tear the bridges formed between the label and the matrix. As shown in the Figure, in a less preferred embodiment, the anvil 24 has a vacuum area V and a positive P pressure area on the anvil 24 so that linerless label is supported on the anvil 24 while it is cut and being carried, and neutral pressure or positive pressure when it is desired for the cut label to be released. The temporary linerless label/carrier system 40 may then be split or separated at the interface of the adhesive of and the release surface of the temporary, reusable liner. The label 44 applied to a substrate (not shown), and the liner may be wound on a capture system (e.g., a roll, not shown). The wound used liner (not shown) may then be used as the source of liner 34 which is fed towards the laminator roll 32. Tension controlling elements 64 that are basically a controlled circuit are associated with the transducer roll 56 and dancer 16 to assure that tension can be adjusted as needed as the matrix 50 passes over idler roller 57.

A matrix 50, comprising the residue of the linerless label 22 after the die cut label 28 is removed from the linerless label 22, is carried away from the anvil roll 24 with a die cutter 48, towards a matrix rewind (e.g., a take up rewind) 52. There is preferably an outfeed pull roll 54 and a transducer roll 56 between the die cutter 48 and the matrix rewind 52. This complete module may be attached or inserted to the conventional lined label applicator so that the temporary linerless label/carrier system 40 is fed into the conventional lined label applicator system at the point where a lined label is normally fed. This physical attachment may be done by snapping the module into receptors on the apparatus, by bolting or welding the module onto the lined label applicating apparatus, by associating an additional frame adjacent to the lined label applicating apparatus, or by any other physical means of associating the module to the lined label applicator. The module can also be a stand alone unit, allowing the reusable liner to feed into the lined label applicator system. In this manner, the module does not have to be physically fixed directly to the structure of the lined label applicator.

This system may, as previously mentioned, be used with commercial applicators, conventional applicators, conventional label liners, and commercial linerless label stock and rolls. Other optional elements within the lined label applicator include a non-stick circumferential surface feed roll, a hardened vacuum anvil cylinder cooperating with a cutting cylinder having a radially extending knife blade, which in turn cooperates with a wiper roller that applies liquid release material to the blade after each cut, and transport means having many unique features. The transport means may include a plurality of conveyor tapes that are spaced in a direction transverse to the direction of conveyance of labels thereby, and a vacuum chamber assists the adhesive from the labels in maintaining the labels in position on the conveyor tapes during conveyance. The conveyor tapes may be typically substantially circular in cross section so as to present a minimal area for engagement with the label adhesive, and the labels are separated from the conveyor tapes by a plurality of non-stick surface stripper rings which extend upwardly above the top surface of the conveyor tapes, and are associated with a peeler roller which bends the labels upwardly as they are deflected by a stripper such as stripper rings, blades, rolls or the like, or even lifted by reduced pressure supports (e.g., vacuum lifters). From the peeler roller and stripper, the labels are moved directly into contact with a moving element. Where, as typical, the labels are moved into contact with moving envelopes, the labels and envelopes pass through nip rollers whereby the pressure sensitive adhesive is activated by pressure.

One aspect of a preferred embodiment of the present invention which helps differentiate the invention from other processes and materials is the use of a generally smaller scale carrier sheet onto which the label material is originally applied. This is because most commercial manufacture of labels would be on wide sheets which are then converted into smaller sizes (narrower widths) for application. In the present invention, as the carrier is reused, it is usually only converted once, and is at least slightly larger than the labels applied (e.g., labels as narrow as 1 cm, 2 cm, 5 cm or the like could be used, up to 10, 15, 20, 25 or up to 30 cm wide). The carrier sheet, as better explained elsewhere herein, may also be thinner than liners that can be used in other manufacturing processes.

A printer, such as a thermal printer (dye hanger, due diffusion, mass transfer, etc.) or an ink printer such as a bubble jet printer, an ink jet print head or the like may also be provided in association with the conveyor tapes for printing indicia on the release coat face of the labels just prior to removal of the labels a conveyor tapes. If the ink is a hot melt ink, a heated platen is preferably provided over the release coat faces of the labels to heat them so that they are receptive to the hot melt ink.

The linerless labels may comprise a substrate having a release coated face and an opposite pressure sensitive adhesive coated face. The substrate of the label may be any sheet forming, film forming, or substrate forming material, preferably a flexible material such as paper, synthetic paper, non-woven sheets, fabric sheets, polymeric film or sheets, and the like. Polymer sheets and films of ethylenically saturated monomers (poly vinyl resins, polyolefins, polyesters, and the like) and fabric sheets (e.g., pages, non-woven fabric, woven fabric, knitted fabric) are very useful. The adhesive may be a thermal adhesive (e.g., poly vinyl resin, polyamide, polyolefins, polyester, etc.), pressure sensitive adhesive (e.g., polyacrylate, polymethacrylate, polyurethane, polysiloxane, etc.) or solvent activatable adhesive (e.g., natural resins, synthetic resins, gums, esters, organic solvent soluble resins, water soluble or dispersible resins, polyvinyl alcohols, gelatins, polyvinyl pyrollidone, poly(meth)acrylates, polyolefins, polyvinylchloride, poly vinylidenechloride, polyvinylacetate, polyvinylacetals, cellulose resins, cellulose acetate butyrate, and mixtures thereof.

The following method steps may be practiced for applying the linerless labels to temporary liners: (a) feeding liner or tape comprising a substrate with a release coated face and an opposite pressure sensitive adhesive coated face in a first direction; (b) partially cutting the tape with micro-perforations into individual labels at a cutting position while the tape is being fed in the first direction; (c) continuously transporting the labels away from the cutting position in a second direction, by disposing the labels and attached matrix on conveyors, with the adhesive coated face contacting a conveyor; and (d) continuously separating the labels from the conveyor and matrix while tearing bridging material between the label and matrix, simultaneously applying the separated labels to moving temporary, reusable supports. It is also possible to provide printing on the release coated face while it is being transported in the second direction, and (e) continuously applying the printed labels to moving elements.

The following method steps may also be practiced for applying linerless labels to moving temporary, reusable supports: (a) Feeding the linerless label sheet comprising a substrate with a release coated face and an opposite pressure sensitive adhesive coated face in a first direction, (b) partially cutting the sheet with micro-perforations into individual labels at a cutting position while the sheet is being fed in the first direction, by bringing the release coat face of the sheet into contact with a hardened anvil, and rotating a separating element such as a knife blade extending radially from a cutting cylinder into contact with the sheet, the knife blade extending transverse to said first direction, (c) continuously transporting the labels away from the cutting position in the second direction, and (d) continuously applying the labels to moving conveyors such as a moving liner by stripping the labels from the matrix by tearing the bridge material.

Typically the elements to which the labels are applied may comprise moving envelopes, boxes, jars, bottles, packages, or the like in which case there is the further step of, after application of a label to a moving element, mechanically pressing the pressure sensitive adhesive coated face of the label into contact with the element to insure proper adherence between them, e.g. by passing them through a pair of nip rolls if thin enough or by using both a back support pressure and a front application pressure surrounding the label and the elements.

Other elements which are desirably present on the module include, for example, a lubricator applicating roll 58 which applies lubricant or release material to the cutting surface 60 surface of the die 48 where the die cutter 48 makes contact with the adhesive (either directly, or cutting through the label to adhesive on the other face), which is preferably in contact with the pressure sensitive adhesive surface (not indicated) of the linerless label 22. Sensing apparatus or elements (e.g., 64) may be present at various locations on the roll to sense and indicate to an operator or control system (e.g., computer or computer program) that the tension should be adjusted by movement of elements or speed adjustment of the system. The vacuum pressure anvil roller 24 may have areas with negative pressure V to secure the labels, or areas with variable pressure (e.g., negative pressure to hold the label, neutral or positive pressure P to release the die cut label 28).

The cutting apparatus may include a hardened anvil vacuum cylinder, rotatable about an axis parallel to the axes of rotation of an idler roll and a feed roll. At least the circumferential surface of the anvil vacuum cylinder should be hardened to preform an anvil function. A vacuum applied through the vacuum cylinder (vacuum cylinders per se are well known) holds the linerless label sheet, and the labels subsequently cut therefrom, on the peripheral surface. Cooperating with the hardened anvil vacuum cylinder for cutting the sheet tape into individual labels there may be provided a cutting cylinder having a radially extending knife blade (or radially spaced knife blades if desired). The cylinder is rotatable about an axis parallel to the axis of the anvil cylinder, and means are provided (such as a frame) for mounting the cutting cylinder adjacent to the anvil cylinder so that the cutting blade just barely makes contact with the hardened surface of the cylinder

To prevent the knife blade from sticking to the sheet as it is cutting the labels, a small amount of liquid release material should be applied to the blade or to the sheet between successive cuts. This may be accomplished, for example, by an idler wiper roll which is a felt roll impregnated with release material, and is mounted for rotation about an axis parallel to the axis of rotation of the cutting cylinder, and adjacent to the cylinder, so that as the blade is rotated away from contact with the hardened anvil surface of the cylinder, it engages the felt and picks up a small amount of release liquid, incrementally rotating the wiper roll as it does so. This is only one of many obvious ways of applying release layers, others including sprays, rollers, drips, ligands, and the like.

The cut length of the labels is determined by the ratio of the feed roll revolutions to cutting cylinder revolutions (and number of cutting blade). This ratio may be changed by any conventional mechanism such as gears, single revolution clutches, or servo-motor controls.

The anvil vacuum cylinder transports the cut labels into association with the temporary reusable label. Further transport of the now temporarily lined label is made to carry it away from the cylinder, ultimately into contact with moving elements, such as envelopes or containers moving in a path. Transport may be done by tension on the composite linerless label, or by support on a conveyor, which may already be a part of the lined label applicator. The adhesive on the adhesive face of the label facilitates adherence of the labels to the temporary, reusable liners so that they can convey the labels in a transport direction to insure that the labels stay in place until it is desired to remove them to the liner. A vacuum cylinder also is preferably provided to secure the cut linerless label I transit to application to the temporary, reusable liner. The vacuum pulls air through the spaces in the surface of the cylinder, thereby providing a force holding labels on the anvil or cylinder.

The linerless label sheet may already have been printed, or it may be desirable to print indicia on the release coated faces thereof. For this purpose a printer, such as an ink jet print head, thermal transfer (mass or dye), contact printer (lithographic, relief, gravure, etc.) or like structure, may be provided. If the ink jet print head applies hot melt ink, just prior to the print head a heated platen is preferably provided for heating the release coat face of the labels to make them receptive for the ink from the print head. Once the labels have been printed and it is desired to apply them to the moving elements, such as envelopes in the desired path, in addition to removing the force of the vacuum chamber it is desirable to positively separate the labels from the temporary, reusable support. For this purpose, a stripping system to remove the labels from the temporary, reusable liner may be used. One type of stripper system comprises one or a plurality of stripper elements, such as stripper rings having nonstick circumferential surfaces, associated with a peeler roll. After separation of the labels from the temporary, reusable support, the pressure sensitive face of each label is fed into contact with an element such as an envelope, and the envelope with label applied may be passed through nip rolls whereby the pressure sensitive adhesive is activated to insure adherence of the label onto the envelope. If the element to which the label is being applied is too thick for use with nip rollers, other conventional instructions for applying pressure to the back of the element while applying pressure from the top of the label may be used. Vise-like mechanisms, pinchers, reciprocating flat plates on both surfaces, and the like may be used.

To remove the labels from the temporary, reusable liner or support, a separating mechanism will be provided by the lined label applicator, which is ordinarily part of the function of that apparatus in removing liners from labels within the apparatus. The separating mechanism comprises a stripper element(s), preferably slides, rollers, ramps, plates, blades, or stripper rings, which extend upwardly above the tops of the temporarily supported linerless label. Another, usually non-flat element in the system, such as a roll or edge (e.g., to bend the labeless liner over a non-flat area to raise an edge which can be freed for engagement and support) is used to bend or deflect each label away from the temporary, reusable liner, usually by raising an edge or corner which can be used to lift the remaining label from the temporary, reusable liner. The stripper, at least the portions that will contact the adhesive faces of the labels, may be made of or coated with non-stick material, such as polytetrafluoroethylene or crosslinked polysiloxanes. The stripper may also be the container or substrate which is to be labeled. A peeler roll, if present, may be mounted for rotation about an axis parallel to that of a vacuum, and may be provided just above the temporary, reusable liner and just prior to the stripper. A peeler roller may aid in removing the labels from the temporary, reusable liner by causing an upward bend in each label, thus causing a portion of the label to travel in a direction that is tangent to both the peeler roll and the stripper, and to be deflected by the stripper. The stripper can rotate with a drive shaft, or could be loosely mounted on a drive shaft so that relative rotation between them is possible, or could be a fixed blade or free wheeling blade.

Drive mechanisms or brakes may be placed within the module on various elements which might need or tolerate a drive mechanism or brakes, such as for example, 8, 14, 20, 26, 32, 52, and 54.

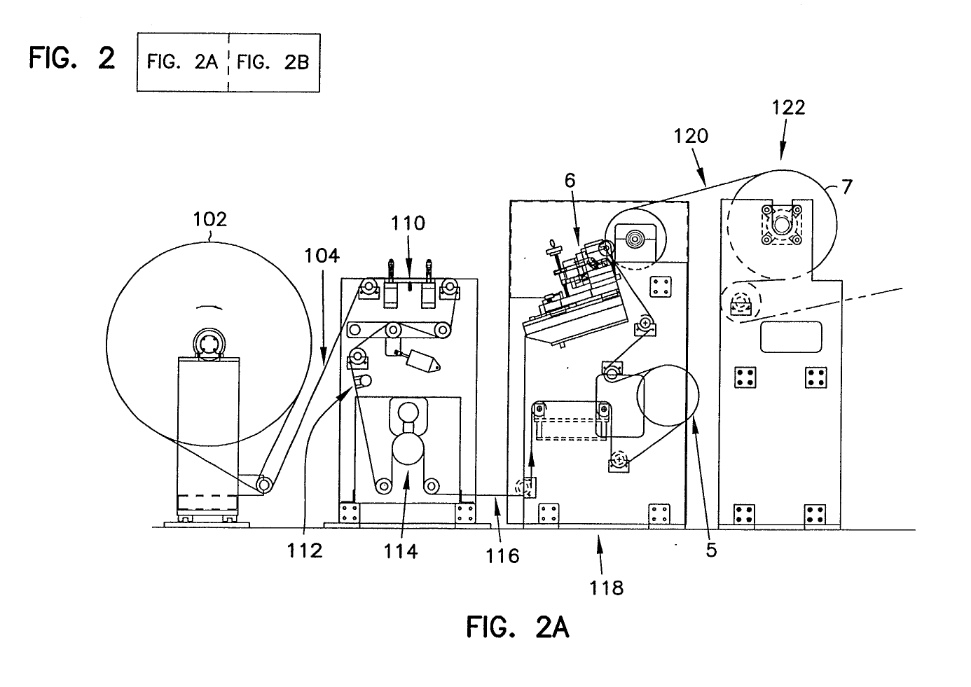

FIG. 2 shows a system 100 in which a roll 102 of printed label material 104 is coated with adhesive prior to association with a temporary, carrier 106 that is supplied from a roll 108. After initial treatment (e.g., splicing at label unwind splice table 110, cleaning on a web cleaner 112, and corona discharge treatment with a corona discharger 114), the prepared and pretreated label material 116 is transferred into an adhesive coating unit 118 where adhesive (e.g., a thermal or hot melt adhesive) is applied. The adhesive coated stock 120 may then be sent to a chill unit 122 and then to the die cutting and application unit 124. Within the die cutting application unit or module 124 may be an infeed/registration roll 126 and a die cutting station with optional vacuum transfer 128. The rotary die may also be chilled to prevent sticking or adhesive transfer. As the individual labels (not shown) are cut with micro-perforations, they may be (according to this description of this aspect of the invention) supported within the die cutting with vacuum transfer segment 128 and applied (adhesive side down or adhesive side up) onto a temporary carrier 106 which has been unwound from a supply roll 108. The carrier material 106 may of course be recycled or reused material. Within the die cutting with vacuum transfer segment 128 may be, for example, an outfeed matrix pull roll 134 which removes the severed matrix (not shown), an infeed temporary carrier pull roll 136, and a laminating roll 138. The laminated, adhesive coated labels (not shown) on the reusable temporary carrier assembly 140 is then transported to a rewind takeup 142 and the matrix 144 is taken to the matrix rewind roll 146.

What is claimed is:

1. A method for enabling a linered label applicator to accept linerless label sheet for application to the surface of elements comprising associating a source of linerless labels on a roll of temporary liner sheet to the linered label applicator, the linerless label having a border for a label, the border having a linear distance defined by a micro-bridged cut along the border so that a composite of:
a) said temporary liner sheet and
b) micro-bridged linerless labels
is fed into said linered label applicator where linered label is normally directed into said linered label applicator.

2. The method of claim 1 wherein the micro-perforated cut along the border comprises a cut wherein less than 10% of the total border retains material that bridges the label and its matrix, and no single bridge element comprises more than 3% of the linear border distance.

3. A method of applying linerless labels to a substrate according to claim 1, wherein individual labels from the micro-bridged linerless label is removed from said temporary liner sheet leaving a matrix on the temporary liner, and said individual labels are applied to a substrate.

4. The method of claim 2 wherein after removal of cut-out linerless label from the temporary liner sheet, the temporary liner sheet is wound into a roll.

5. The method of claim 2 wherein the temporary liner comprises a sheet of less than 0.032 mm in thickness.

6. The method of claim 5 wherein the temporary liner comprises a polymer film of less than 0.025 mm in thickness.

7. The method of claim 2 wherein said roll is used to feed liner on a thin liner of less than 0.032 mm as a source of label comprising the steps in said applicator of:
bending said linerless label on a reusable, temporary liner to partially remove at least a part of an edge of said linerless label from said temporary liner,
having at least said lifted edge placed into contact with a surface to which the linerless label is to be applied, and
attaching said linerless label to said surface.

8. The method of claim 3 wherein the micro-bridge is torn as label is removed from matrix in said linered label applicator.

9. The method of claim 4 wherein said roll is used to feed liner on a reusable, temporary liner as a source of label comprising the steps in said applicator of:
bending said linerless label on a reusable, temporary liner to partially remove at least a part of an edge of said linerless label from said reusable, temporary liner,
having at least said lifted edge placed into contact with a surface to which the linerless label is to be applied, and
attaching said linerless label to said surface.

10. The method of claim 5 wherein said roll is used to feed liner on a reusable, temporary liner as a source of label comprising the steps in said applicator of:
bending said linerless label on a reusable, temporary liner to partially remove at least a part of an edge of said linerless label from said reusable, temporary liner,
having at least said lifted edge placed into contact with a surface to which the linerless label is to be applied, and
attaching said linerless label to said surface.

11. A source of linerless labels comprising a composite of an elongate sheet of reusable, temporary liner having adhered to a low adhesion surface of said reusable, temporary liner an adhesive face of a micro-bridged cut linerless label, said composite being rolled into a roll.

12. The source of linerless labels of claim 11 wherein said roll has a non-adhesive face of said linerless label facing radially outwardly.

13. The source of linerless labels of claim 12 wherein said face of said linerless label facing radially outwardly has a non-adherent coating on the radially outwardly facing face.

14. A method for creating a label on a temporary reusable carrier comprising the steps of:
a) printing an image onto at least one face of a first sheet material;
b) applying adhesive to at least one face of the printed first sheet material;
c) cutting the sheet material into individual labels having a micro-bridged cut along a border of the label within a label stock sheet, the micro-bridged cut comprising a cut wherein less than 10% of the border retains material that bridges the label and its matrix from the label stock sheet, and no single bridge element comprises more than 3% of the linear border distance;
d) applying a face of the individual labels to a temporary carrier sheet to form a sheet of precut label stock.

15. The method of claim 14 wherein precut label stock is fed into a label applicator, microbridged labels from the label stock are applied to substrates, and the temporary carrier is removed.

16. The method of claim 14 wherein the temporary liner comprises a sheet of less than 0.032 mm in thickness.

17. The method of claim 16 wherein the temporary liner comprises a polymer film of less than 0.025 mm in thickness.

18. An apparatus for enabling a linered label applicator to accept linerless label sheet for application to the surface of elements comprising a source of linerless labels on a roll of temporary liner sheet to the linered label applicator, the linerless label having a border for a label, the border having a linear distance defined by a micro-bridged cut along the border so that a composite of:
a) said temporary liner sheet and
b) micro-bridged linerless labels
a feeder for feeding the composite into said linered label applicator, and
a stripping system to remove label from matrix by severing microbridges, and
an applicator system for applying stripped label to a substrate.
